(19) United States
(12) Patent Application Publication
(10) Pub. No.: US 2007/0168294 A1
(43) Pub. Date: Jul. 19, 2007

(54) Digital content use right management system

(75) Inventor: Tatsuya Tsurukawa, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 10/583,975

(22) PCT Filed: Dec. 25, 2003
(86) PCT No.: PCT/JP03/16762

§ 371 Date: Mar. 22, 2007

(51) Int. Cl. G06Q 99/00

(52) U.S. Cl. 705/59

(57) ABSTRACT

A digital content management system to decide whether or not a digital content is available depending on a location of a user who desires to use the digital content is provided.

A digital content use right management system includes a digital content server device 1 to store an encrypted digital content, a license server device 2 to generate and transmit license data 4 containing an available location of the digital content and a decryption key to decrypt the digital content, and a client device 3 to receive the digital content from the digital content server device 1, to receive the license data 4 from the license server 2, and based on a condition for use defined by its use condition, to determine whether or not to decrypt the digital content with the decryption key contained in the license data 4. In the digital content use right management system, the client device 3 includes a current location identifying means to obtain a current location, and a license data processing means to compare the current location obtained by the current location identifying means with the available location contained in the license data 4, and to determine whether or not to decrypt the digital content.

### TECHNICAL FIELD

The present invention relates to a digital content use right management system, and more specifically to a digital content use right management technology that includes location information in a use condition of digital contents.

### BACKGROUND ART

It is introduced a technology for managing a use right of digital contents by relating location information to availability management of digital contents in references such as JP2000-11538. Whereas this technology discloses a method to control use of digital contents based on location information, it is premised on the location information being stored in the digital contents.

However, according to this technology, there is a problem in that a load for managing location information is extremely heavy, since the location information has to be stored in each digital content. If unique location information is assigned to each user and to each digital content additionally, and if management of digital contents is performed for each location information, kinds of the location information to be managed will inevitably become extremely huge. On the other hand, the location information may be subject to frequent change, in such cases as when locations to use digital contents are changed or added according to circumstances of users. If this is the case, it will be extremely difficult to perform the operation management with the conventional art.

Moreover, when there are changes in available locations according to requests by digital content user side, or setting errors in the digital content available locations, digital contents themselves have to be recreated after the available location information is corrected, and therefore, there is a problem in that the load of operational management for such unforeseen situations is heavy.

It is one of the purposes of the present invention to solve the above-mentioned problems. The present invention provides a digital content use right management system which does not entail recreation of digital contents themselves when adding or changing the range of available locations of digital contents, and then requires a light load of operation management, while realizing a digital content use right management system having a high-security level by placing limits on the available locations of digital contents.

### DISCLOSURE OF THE INVENTION

There is provided according to one aspect of the present invention a digital content management system including:

a digital content server to store a digital content encrypted;

a license server device to generate and transmit license data containing a use condition of the digital content and a decryption key to decrypt the digital content; and

a client device that is connected to the digital content server and the license server device via a network, to copy the digital content from the digital content server, to receive the license data from the license server, and based on a condition for use defined by the use condition in the license data, to decide whether or not to decrypt the digital content with the decryption key contained in the license data,

a digital content use right management system, wherein

the license server device generates the license data containing an available location of the digital content as the use condition, and

the client device includes a current location identifying means to obtain a current location, compares the current location obtained by the current location identifying means with the available location contained in the use condition in the license data, and decides whether or not to perform a decryption of the digital content.

As described above, according to the digital content management system of the present invention, prevention of fraudulent use of digital contents is made more definitive compared to the conventional art, by putting restrictions of location range to the use conditions of digital contents. Therefore, this system is to promote distribution of digital contents and thus has an effect to form a new distribution market of digital contents.

### BRIEF DESCRIPTION OF THE DRAWINGS

FIG. 1 is a block diagram showing a structure of a digital content use right management system according to the first embodiment of the present invention.

FIG. 2 is a block diagram showing a detailed structure of a digital content server device according to the first embodiment of the present invention.

FIG. 3 is a block diagram showing a detailed structure of a license server device.

FIG. 4 is a block diagram showing a detailed structure of a client device.

FIG. 5 is a diagram showing an example of a structure of a license data.

FIG. 6 is a diagram showing an example of a structure of a location information database.

FIG. 7 is a diagram showing a structure of an electronic location information medium.

FIG. 8 is a flowchart of a document data generating process.

FIG. 9 is a diagram showing a structure of a key database.

FIG. 10 is a flowchart of operations of a digital content use right management system during browsing of electronic documents.

FIG. 11 is a detailed flowchart of a license data generating process.

FIG. 12 is a diagram showing an example of a structure of a use right-use condition table.

FIG. 13 is a diagram showing a detailed structure of an attribution information field of an attribution information database.

FIG. 14 is a flowchart of a license data generating process using an electronic location information medium.

FIG. 15 is a flowchart of a process for registering a location.

FIG. 16 is a flowchart of a process for deciding whether a license is issuable depending on a current location.

FIG. 17 is a diagram showing another example of the structure of the use right-use condition table.

FIG. 18 is a diagram showing an example of a structure of a license issuance history database.

FIG. 19 is a diagram showing an example of a structure of license data.

FIG. 20 is a diagram showing an example of a structure of license data.

FIG. 21 is a block diagram showing a structure of a digital content use right management system according to the second embodiment of the present invention.

FIG. 22 is a block diagram showing a detailed structure of a digital content server device according to the second embodiment of the present invention.

FIG. 23 is a block diagram showing a detailed structure of a license server device according to the second embodiment of the present invention.

FIG. 24 is a block diagram showing a detailed structure of a client device 3 according to the second embodiment of the present invention.

FIG. 25 is a flowchart of a process in a digital content server device according to the second embodiment of the present invention.

FIG. 26 is a diagram showing an example of a table structure of an elevator database.

FIG. 27 is a flowchart of operations of a system during browsing of a maintenance manual.

FIG. 28 is a flowchart of a digital content browsability judging process.

### PREFERRED EMBODIMENTS FOR CARRYING OUT THE INVENTION

### Embodiment 1

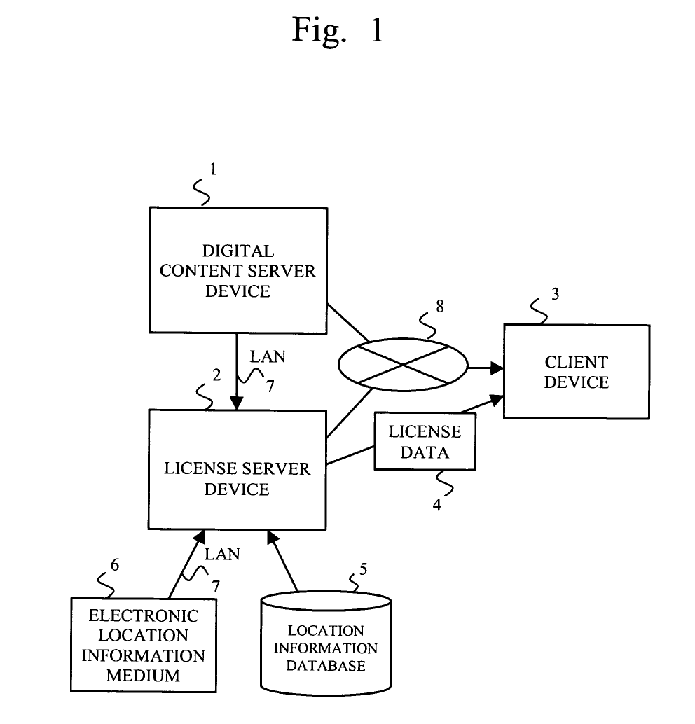

FIG. 1 is a block diagram showing a structure of the digital content use right management system according to the first embodiment of the present invention. In the diagram, a digital content server device 1 is a device that encrypts document data, stores the encrypted document data, and distributes the encrypted document data via a network in response to user requests. A license server device 2 is a device that stores a decryption key of the encrypted document data and an ID of the document data, and transmits license data including the decryption key to the network in response to user requests.

A client device 3 is a device that obtains the encrypted document data from the digital content server device 1 via the network and the license data including the decryption key from the license server device 2, decrypts the encrypted document data and allows browsing by a user. The client device 3 is portable, and a user carries or moves the client device 3 to access digital contents at different places.

License data 4 is electronic data including, besides the decryption key, a use right such as allowance to browse and allowance to print, and a use condition such as time window of documents, which is transferred via the network and stored in a random access memory or a nonvolatile storage device, such as a hard disk drive, mounted on the license server device 2 and the client device 3.

A location information database 5 is a database system or a file in a file system configured as accessible from the license server device 2, which stores logical location information describing location information logically and physical location information location information in an interrelated manner. “Logical location information” is a label or a symbol by information of which a location can be uniquely specified, such as a name of a venue where a certain event is held or a name of a conference room where a meeting is held (ex. B-1 Conference Room etc.). On the other hand, the physical location information is physically represented location information, such as range of latitudes, longitudes, and altitudes. In addition to representation in a latitude and longitude etc., the physical location information may be represented by a distance from a prescribed reference point or by using coordinates, for example, or such a structure can be adopted wherein absolute location information is stored in a separate table different from the location information database, and a pointer to the separate table (an identifier to uniquely specify information) is kept in the physical location information of the location information database. Additionally, the location information database 5 in the diagram may be formed by independent computer device different from the license server device 2, or may be formed by a part of a storage device such as a hard disk drive managed by the license server device 2.

An electronic location information medium 6 is a memory medium that registers and stores two-dimensional or three-dimensional map information and attributions of each location. An electronic map can be cited as a representative example of such electronic location information medium 6. However, the electronic location information medium 6 is not limited to the electronic map, and it is sufficient if it can store information related to each point in an area with spatiality (defined by coordinates or latitudes and longitudes, etc.).

A LAN 7 is a network connecting the digital content server device 1 and the license server device 2, or the license server device 2 and the electronic location information medium 6. An Internet 8 is a network connecting the digital content server device 1 and the client device 3, or the license server device 2 and the client device 3, which may either be wired or wireless.

The digital content server device 1, the license server device 2 and the client device 3 are all composed of combinations of computer devices equipped with central processing units (CPU: Central Processing Unit), random access memories and nonvolatile storage devices such as hard disk drives, and computer programs to allow the computer devices to execute a prescribed operation. Nevertheless, dedicated circuits such as DSPs (Digital Signal Processors) or ASICs (Application Specific Integrated Circuits), which are configured to perform similar functions, can be used. Further, it is acceptable to configure one device (or a computer) to serve as both the digital content server device 1 and the license server device 2. Additionally, it is also possible to configure the electronic location information medium as a component in a storage device of the license server device 2. In such a case, it is not necessary to use the LAN 7.

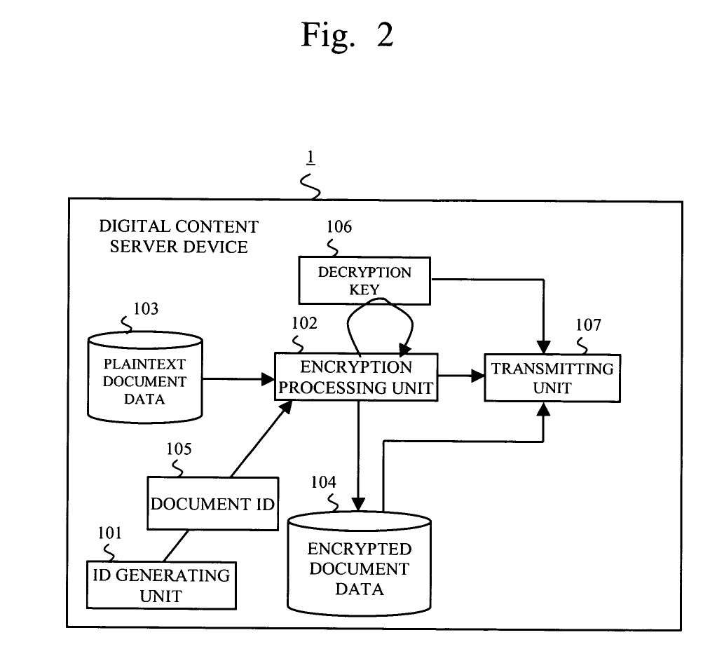

Next, a detailed structure of the digital content server device 1 is described. FIG. 2 is a block diagram showing a structure of the digital content server device 1. In the figure, an ID generating unit 101 is a part to generate IDs to be assigned to each of the documents managed by the digital content use right management system. The IDs are unique IDs in the system. There are several heretofore known methods for generating unique IDs. For example, there is a method using a number string consisting of many digits generated by combining time stamps formed of year, month, day and time on millisecond time scale, and random numbers. Nevertheless, any method can be used in this case. In this and the following explanations, it is meant by the word “part” a computer program that allows a computer to execute corresponding functions when the device is composed of a combination of a computer and a computer program. Meanwhile, when the device is composed of a dedicated circuit, “part” is implemented by a circuit or an element to implement corresponding functions.

An encryption processing unit 102 is a part that generates an encryption key or a decryption key, and encrypts input data. Plaintext document data 103 is document data stored in a memory device, a circuit or a memory medium of the digital content server device 1, which is document data whereon an encryption process is not performed. Encrypted document data 104 is document data, which is the plaintext document data 103 encrypted by the encryption processing unit 102, and which is stored in the memory device, the circuit or the memory medium of the digital content server device 1. A document ID 105 is an ID generated by the ID generating unit 101. Besides, a decryption key 106 is a decryption key generated by the encryption processing unit 102. In this system, the symmetric-key cryptography system is used and the same key is assigned to the encryption key and the decryption key. Therefore, in some cases, the decryption key 106 may arbitrarily called an encryption key 106 for explanation. A transmitting unit 107 is a part that transmits the encrypted document data to the network.

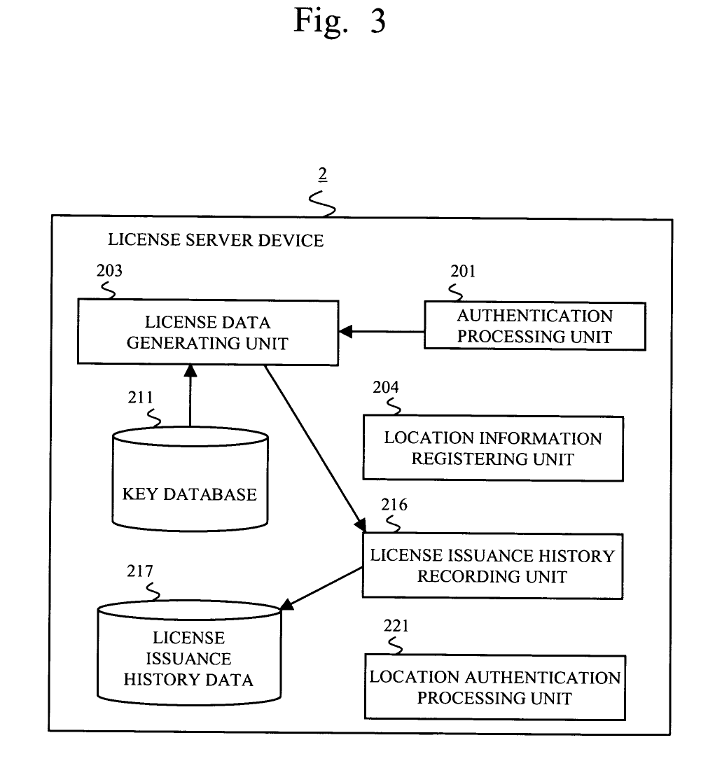

Next, a detailed structure of the license server device 2 is described. FIG. 3 is a block diagram showing a structure of the license server device 2. In the figure, an authentication processing unit 201 is a part that performs authentication of the client device. A license data generating unit 203 is a part that generates license data. A location information registering unit 204 is a part that registers location information transmitted from the client device to the location information database 5 or the electronic location information medium 6. A key database 211 is a key database that holds sets of the document IDs for each document and the decryption keys. A license issuance history recording unit 216 is a part that records issuance of license data according to requests for license data issuance. License issuance history data 217 is a file for the license issuance history recording unit 216 to record requests for license issuance. A location authentication processing unit 221 is a part that receives the requests for license data issuance from the client device and determines whether or not to issue based on a location of the client device at the time.

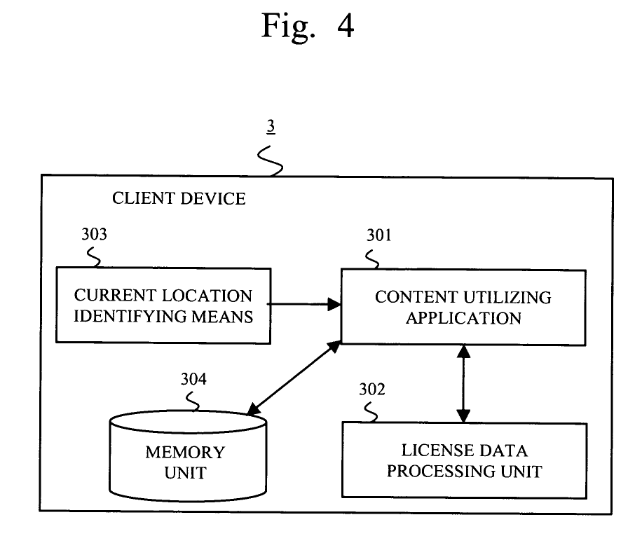

Next, a detailed structure of the client device 3 is described. FIG. 4 is a block diagram showing a structure of the client device 3. In the figure, a digital content utilizing application 301 is computer software that renders digital contents.

A license data processing unit 302 is a part that controls utilization of digital contents according to the license data generated by the license server device 2. In the client device 3, the license data is stored in a volatile storage such as a random access memory, in a circuit or a nonvolatile storage such as a hard disk drive not shown in the figure.

A current location identifying means 303 is a part that identifies a current location of the client device 3, which obtains a latitude, a longitude and an altitude by receiving a GPS signal. Further, by using a gyroscope having an inertial sensor in combination with a GPS, positional measurement can be made in doors or in vehicles, where radio waves cannot be received from GPS satellites.

A memory unit 304 is an element, a circuit, a memory medium or a combination thereof that stores data to be browsed by a user, such as digital contents, and is composed of a hard disk drive, a CD-ROM drive, and a DVD-ROM drive.

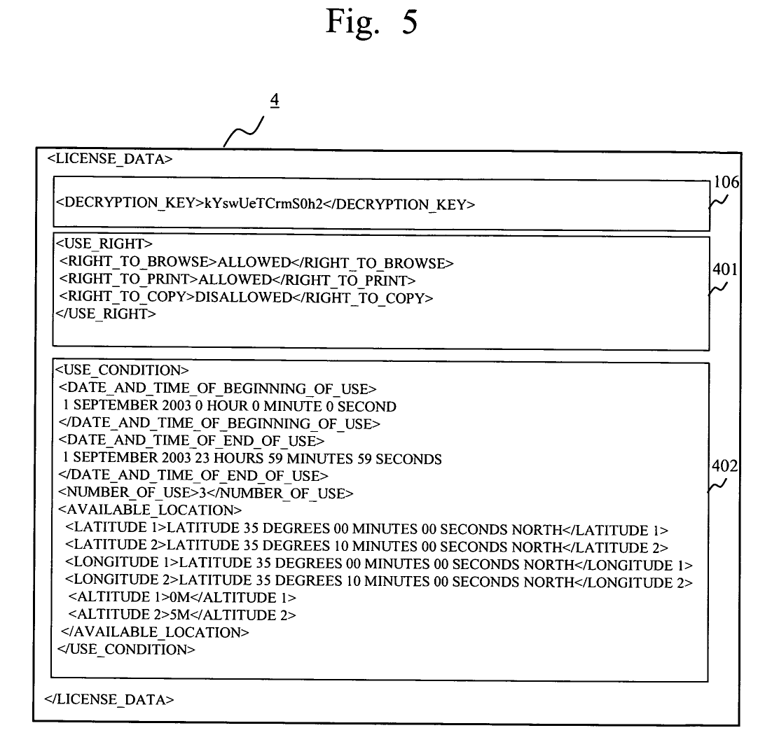

Next, a structure of license data 4 is described. FIG. 5 is a figure showing an example of the structure of the license data 4. The license data 4 is data that defines, for example, the decryption key 106 of digital contents, a use right 401 representing operations that can be performed to digital contents, such as browsing, printing, copying, and a use condition 402 representing a time window, a browsable number of times, a browsable location, etc. The example of the license data 4 shown in the diagram describes the decryption key 106, the use right 401 and the use condition 402 in an XML (eXtensible Markup Language) format. However, the license data 4 may be written in other data formats.

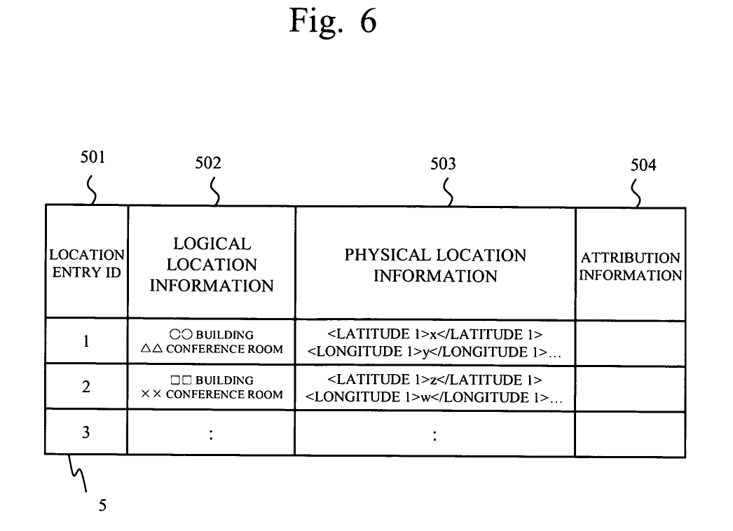

Next, a detailed structure of the location information database 5 is explained. FIG. 6 is a diagram showing an example of a structure of the location information database 5. In this example, each record of the location information database 5 has each field of a location entry ID 501, logical location information 502, physical location information 503 and attribution information 504. However, it is also possible to configure the location information database 5 to have other fields. The location entry ID 501 is a unique ID, and has a feature that by specifying this ID, one record of the location information database 5 corresponding to the ID is uniquely determined. By referring to the location information database 5, a relation between the logical location information 502 and the physical location information 503 is obtained, and it is possible to obtain corresponding physical location information 503 from logical location information 502, or corresponding logical location information 502 from physical location information 503. Further, attribution information 504 defines processing methods in the cases when the use right or a use form of digital contents does not meet conditions.

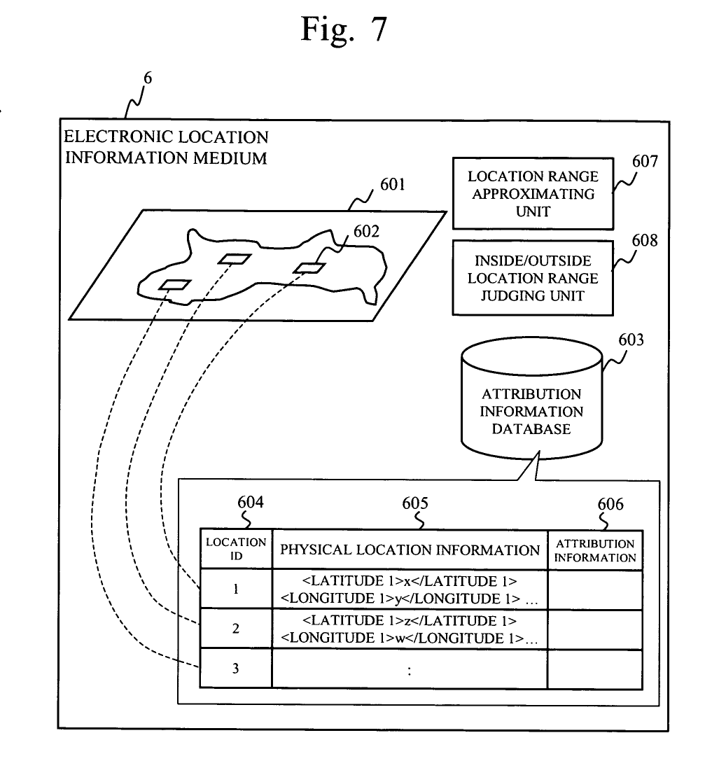

Next, a detailed structure of the electronic location information medium 6 is explained. FIG. 7 is a diagram showing a structure of the electronic location information medium 6. The electronic location information medium 6 is equipped with a map displaying unit 601, an attribution information database 603, a location range approximating unit 606 and an inside/outside location range judging unit 607. The map displaying unit 601 has functions to display a map, and additionally, the map displaying unit 601 enables to specify an arbitrary location or range of the displayed map by a GUI (Graphical User Interface) operation, for example. Additionally, the maps displayed on the map displaying unit 601 are two-dimensional or three-dimensional maps. Each location or range 602 in the map are made relating to the records of attribution data stored by the attribution information database 603. The records of the attribution information database 603 have at least fields of a location ID 604, physical location information 605 and additionally, attribution information 606. The location ID 604 is an ID uniquely assigned to each location and range in the map displayed on the map displaying unit 601, and the physical location information 601 and the attribution information 606 can be searched by using the ID as a key. The physical location information 605 is information describing physical location information of each location and range of the map, and is expressed by means of coordinates, a latitude and longitude, or a distance from a reference point, etc. The attribution information 606 is additional information held by the location and the range. The location range approximating unit 607 is a part that approximates the location range 602 designated by a GUI operation, by a set of arbitrary rectangles (two-dimension) or arbitrary rectangular parallelepipeds (three-dimension) whereby latitudes, longitudes and altitudes are defined, and reflects such information to the physical location information 605. The inside/outside location range judging unit 608 is a part that judges whether or not a coordinate is within a physical location range corresponding to a location ID, when the location ID and a two-dimensional or a three-dimensional coordinate is provided to the electronic location information medium 6 from outside.

(Initialization Process)

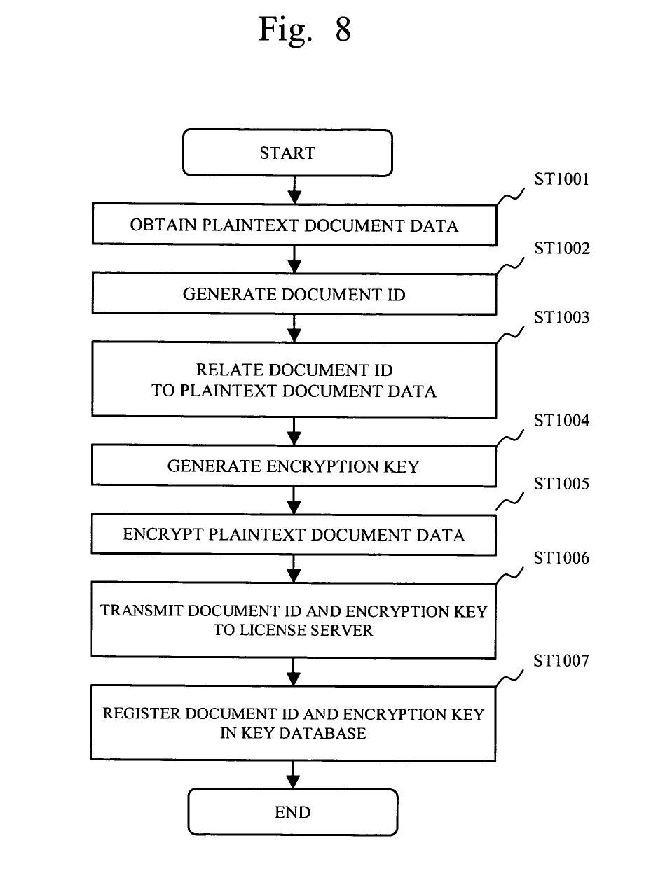

Next, an initialization process performed by the digital content server device 1 and the license server device 2 is described. FIG. 8 is a flowchart of a document data generating process.

In Step ST1001 in the diagram, the encryption processing unit 102 in the digital content server device 1 obtains a piece of the plaintext document data 103. On the other hand, the ID generating unit 101 in the digital content server device 1 generates the document ID 105 (Step ST1002). The process in Step ST1002 can be performed prior to the process in Step ST1001.

Next, the encryption processing unit 102 relates the document ID 105 generated by the ID generating unit 101 to the plaintext data 103 (Step ST1003). Then, the encryption processing unit 102 generates the encryption key (equal to the decryption key 106) (Step ST1004). Subsequently, the encryption processing unit 102 generates the encrypted document data 104 by linking the plaintext document data 103 and the document ID 105 related to the plaintext document data 103 and by encrypting them (Step ST1005). The transmitting unit 107 in the digital content server device 1 transmits the document ID 105 and the decryption key 106 to the license server device 2 via the LAN 7 (Step ST1006).

Next in Step ST1007, the license server device 2 registers and stores a set of the document ID 105 and the encryption key 106 transmitted from the digital content server device 1 in the key database 211.

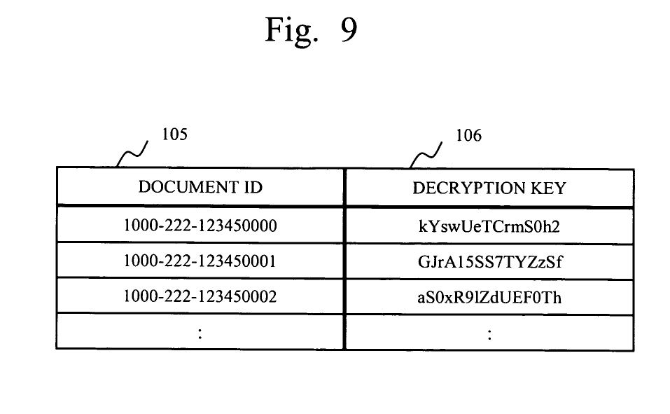

FIG. 9 is a diagram showing a structure of the key database 211 wherein the set of the document ID 105 and the decryption key 106 generated in the above-mentioned process is stored. The processes from Step ST1001 through Step ST1007 are performed to all the documents as subjects of digital content management. The above-mentioned are the contents of the initialization process in the system.

(Process During Browsing of Electronic Documents)

Next, an operation of the system when a user handles electronic documents at a predesignated place is described by using a diagram. It is assumed that a user stores the encrypted document data 104 in the memory unit 304 of the client device 3 by some methods prior to browsing of electronic documents. It is also assumed that the user carries the client device 3 with its power supply shut off, moves to a document available location, such as a designated conference room, then powers the client device 3 at the place, and initiates a networking connection with the digital content server device 1 and the license server device 2 via the Internet 8, etc.

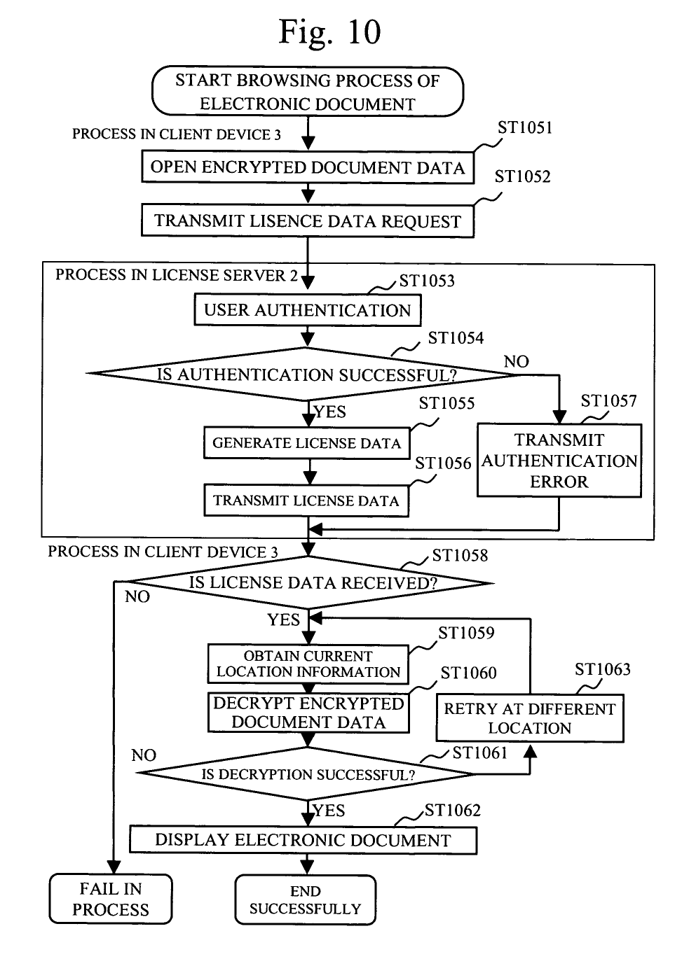

FIG. 10 is a flowchart of operations in the digital content use right management system during browsing of electronic documents by a user. First, in Step ST 1051, the digital content utilizing application 301 of the client device 3 tries to open the encrypted document data 104 stored in the memory unit 304. A user gives a direction to an operating system of the client device 3 to start up the digital content utilizing application 301 after the user powers the client device 3.

Then, in Step ST1052, the license data processing unit 302 of the client device 3 detects that the license data 4 does not exist in the client device 3, and requests license data to the license server device 2. The client device 3 transmits the document ID of the encrypted document data opened in Step ST1051, and authentication information, such as a user ID and a password, which are necessary to perform authentication of the user, to the license server device 2 to request a transmission of the license data 4. Then, the operation is moved to the license server device 2 from the client device 3.

In next Step ST1053, the authentication processing unit 201 in the license server device 2 performs authentication based on the authentication information such as the user ID and the password transmitted from the client device 3. In Step ST1054, it is judged whether or not the authentication is successful, and when the authentication is successful, it is moved on to Step ST1055. In Step ST1055, the license data generating unit 203 generates license data, and in next Step ST1056, the license data is transmitted to the client device 3 via the Internet 8. A license data generating method in Step ST1055 will be described later in detail.

On the other hand, when the authentication results in failure in Step ST1054, an authentication error is transmitted to the client device in Step ST1057. These are the processes in the license server device 2. Next, the operation is moved to the client device 3.

In Step ST1058, the license data processing unit 302 of the client device 3 detects whether or not the license data can be received, and when the license data cannot be received, the processes are terminated resulting in failure of browsing the electronic documents. On the other hand, when the license data can be received, in Step ST1059, the current location identifying means 303 obtains a current location. A concrete method for obtaining the current location will be described later.

Next, in Step ST1060, the license data processing unit 302 decrypts the encrypted document data 104. In Step ST1061, the license data processing unit 302 judges whether or not the decryption is successful, and when the decryption proves successful, the digital content utilizing application 301 displays the document for the user in Step ST1062, and the electronic document browsing process is completed. When it is proved that the decryption process results in failure in Step 1061, the user moves again to the document available location in Step 1063 and repeats the processes from Step 1059 until the encrypted document data is decrypted.

As shown above, the client device 3 allows the user to browse the encrypted document data 4 only when the user is in a specific location.

(Generating Process of License Data)

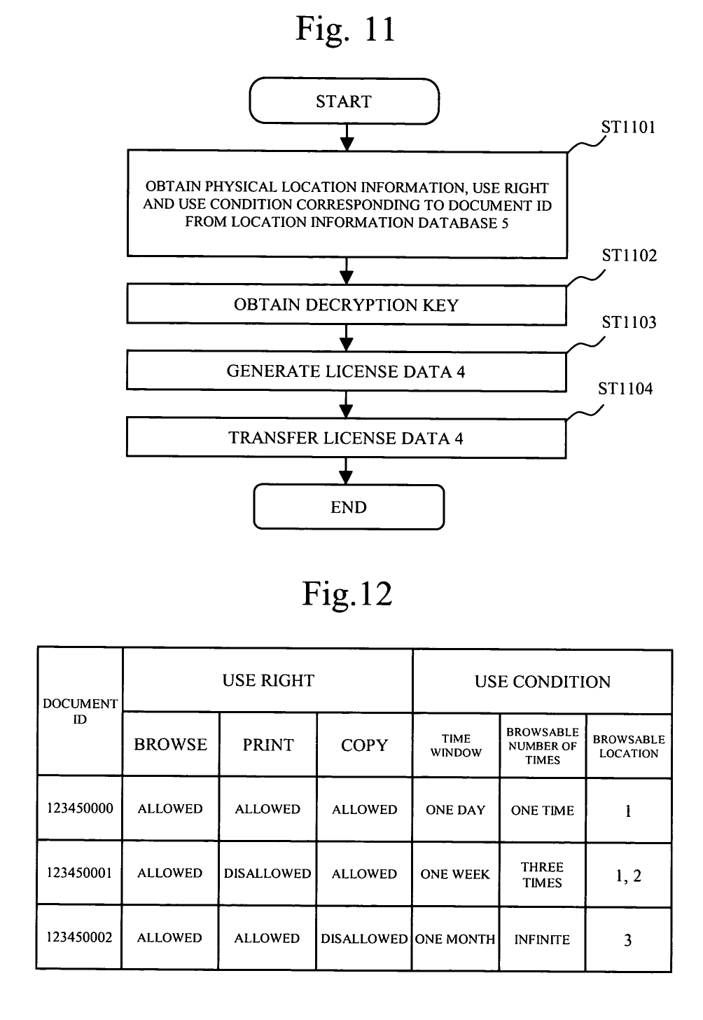

Next, the license data generating processes in Step ST1055 in the flowchart of FIG. 10 is described in detail. FIG. 11 is a detailed flowchart of the license data generating process. First, in Step ST1101 in the diagram, the license data generating unit 203 obtains the logical location information 502 corresponding to the document ID transmitted with a license data transmission request by the client device 3, from the location information database 5. At the same time, the corresponding physical location information 503 is obtained. Further, the license data generating unit 203 references the attribution information 504 and obtains the use right of the digital content and the use condition apart from the available location (time window, etc.). In Step ST1102, the key database 211 retrieves the decryption key 106 corresponding to the document ID. By using the decryption key, the use right, the use condition including the available location information, the license data 4 is formed in Step ST1103. Finally, in Step ST1104, the license data is returned to the client device 3. As described above, it is possible to generate the license data 4.

Besides method for generating the license data 4 each time the transmission of the license data 4 is requested by the client device 3, it is also possible to draft use right-use condition tables for each document ID beforehand, and to allow the license data generating unit 203 to obtain the use right and the use condition including the available location from such tables, based on the document ID upon receipt of the transmission request, to obtain the decryption key 106 likewise from the key database 211 automatically, and to generate the license data. FIG. 12 is a diagram showing an example of a structure of such a use right-use condition table. In the example of FIG. 12, by storing the values of the location entry ID 501 field of the location information database 6 in the browsable location field of the records of each table, both the data can relate with each other.

(License Data Generating Process using the Electronic Location Information Medium)

In the above-mentioned processes, the available location of the digital contents is determined only according to the document ID. However, it is also possible to employ a configuration that changes the available location depending on the attribution of a user, by using the electronic location information medium 6. Further, it is also possible to change the use right and the use condition, such as the time window and the browsable number of times, depending on the location information. An example of such a configuration is hereinafter described.

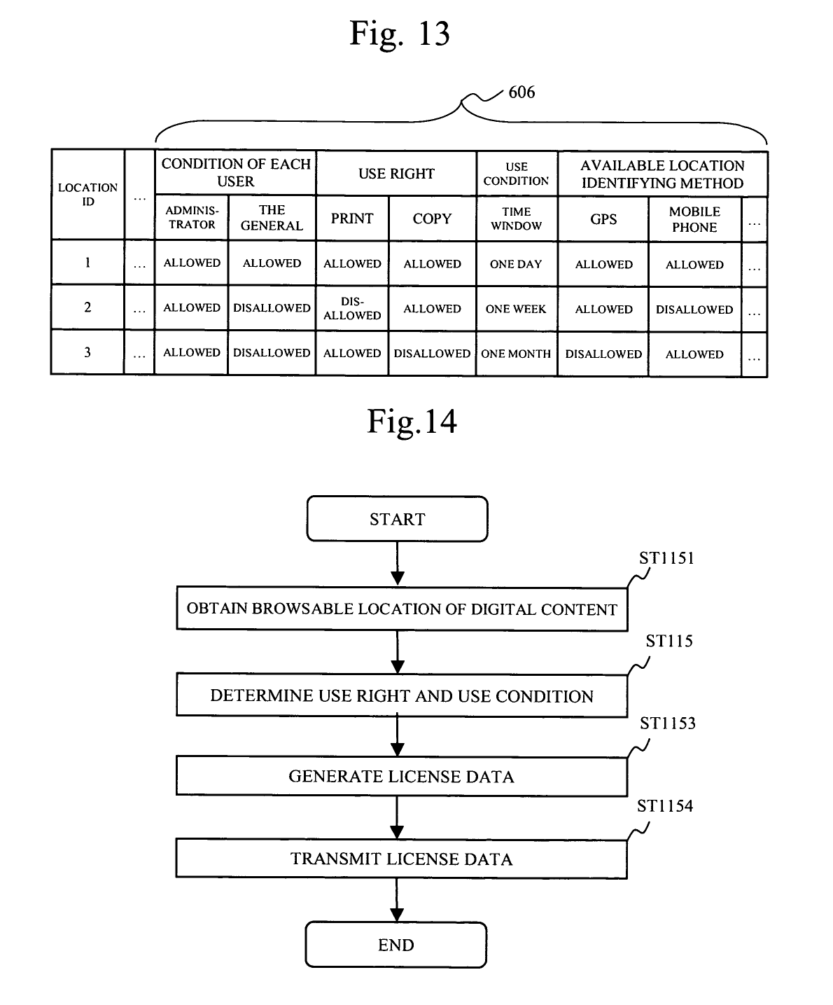

Prior to such a configuration, fields of availability by an administrator, availability by a general user, availability of print, availability of copy, time window, etc. are added to the attribution information field 606 of the attribution information database 603 in the electronic location information medium 6. FIG. 13 is a diagram showing a detailed configuration of the attribution information field 606 of the attribution information database 603.

Next, a license data generating process in the configuration using the electronic location information medium 6 is described. FIG. 14 is a flowchart of the license data generating process using the electronic location information medium 6. First, in Step ST1151, the license data generating unit 203 obtains a location from which browsing of an encrypted document is attempted according to a document ID transmitted from the client device 3. Here, it is assumed that a document ID equal to 1234500002 in FIG. 12 is transmitted. Then, as a result, it is judged that a browsable location in the use condition corresponding to the document ID 1234500002 is 3. Next, in Step ST1152, an entry corresponding to the location ID=3 is referenced, and the physical location information, the use right and the use condition are retrieved. For the overlapped part of the conditions indicated in FIG. 12 and FIG. 13, AND is performed on both the condition (It is judged “disallowed” unless the both indicate “allowed”).

In Step ST1153, the license data 4 is finally generated. In the present example, the license data is: as the use right, browsing allowed, printing allowed, and copying disallowed; as the use condition, time window being one month, and browsable number of times being infinite; and browsble location being the physical location information corresponding to the location ID=3 in FIG. 13. In Step ST1154, the license data 4 is returned to the client device.

According to the above-mentioned method, it is possible to automatically generate unique license data 4 corresponding to the document ID, the attribution of the user and the available location, and eventually to automate an issuance process of licenses.

Further, as described in FIG. 13, it is also possible to register beforehand a location identifying method available at a place for each ID. By transmitting a type of the current location identifying means 303 mounted on the client device 3 to the license data 4 at the time the license data is requested by the client device 3, the license server 2 is able to judge whether the license data 4 is issuable for the client device 3 or not. For example, in FIG. 13, when the client device 3 only has a GPS as the current location identifying means 303, it is possible to reject issuance of the license data 4 for a user who attempts to browse digital contents at a place corresponding to the location ID=3.

(Method to Register Location Information)

The above-mentioned explanation is based on the premise that the available location information of digital contents is registered beforehand in the location information database 5 or the electronic location information medium 6. Therefore, it is next described a method to register arbitrary locations in the location information database 5 or the electronic location information medium 6. It is assumed in the following explanation a case in which conference materials and the like can be referenced only in a certain conference room in a building owned by a company.

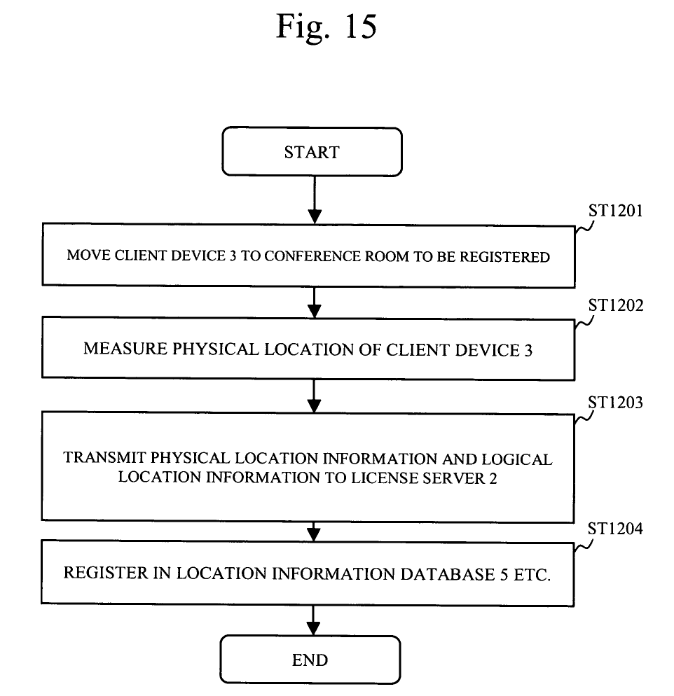

First, the client device 3 equipped with the current location identifying means 303 is practically taken to a conference room wherein conference materials are to be referenced, and registration is performed. FIG. 15 is a flowchart of a process wherein the client device 3 is directly taken into the conference room and a location registration is performed.

First, in Step ST1201, the client device 3 is taken into a conference room to be registered. In Step ST1202, the current location identifying means 303 mounted on the client device 3 measures a physical location of the conference room. In this case, it is assumed that the current location identifying means 303 measures not only a latitude, longitude and altitude of a certain point, but also properly amends a range of latitudes, longitudes and altitudes of the current location measured by an operator in consideration of the size of the conference room.

Next, in Step ST1203, the measured physical location information and the logical location information such as the name of the conference room are transmitted to the license server device 2. In Step ST1204, the location information registering unit 204 of the license server device 2 registers such information to the location information database 5 or the electronic location information medium 6. In the above-mentioned processes, it is possible to register a latitude, longitude and altitude of the conference room wherein digital contents are scheduled to be used.

Further, it may be possible to obtain an accurate latitude, longitude and altitude of the conference room beforehand from a measurement service or map data, and to directly register such data to the location information database 5 or the electronic location information medium 6.

Furthermore, when the conference room already registered is changed, it is possible to adjust to a conference room at a new location by repeating the above-mentioned operations.

(Decide Whether License Data is Issuable Depending on the Current Location)

In the above-mentioned processes, such a configuration is described that browsing of digital contents is allowed when a current location meets the browsable location condition for it to be allowed by the license data after obtaining the license data. However, it is also possible to decide whether the license data is issuable depending on a current location.

For example, when considering a case wherein authentication information of an employee has been leaked at the time of issuing a license for an important internal confidential document, a source of request might be a malicious third party. In such a case, by limiting a location of the client device for which the license data is issued, for example, inside the company building, it is possible to confirm that the license is properly issued to employees, since a third party usually cannot enter the company.

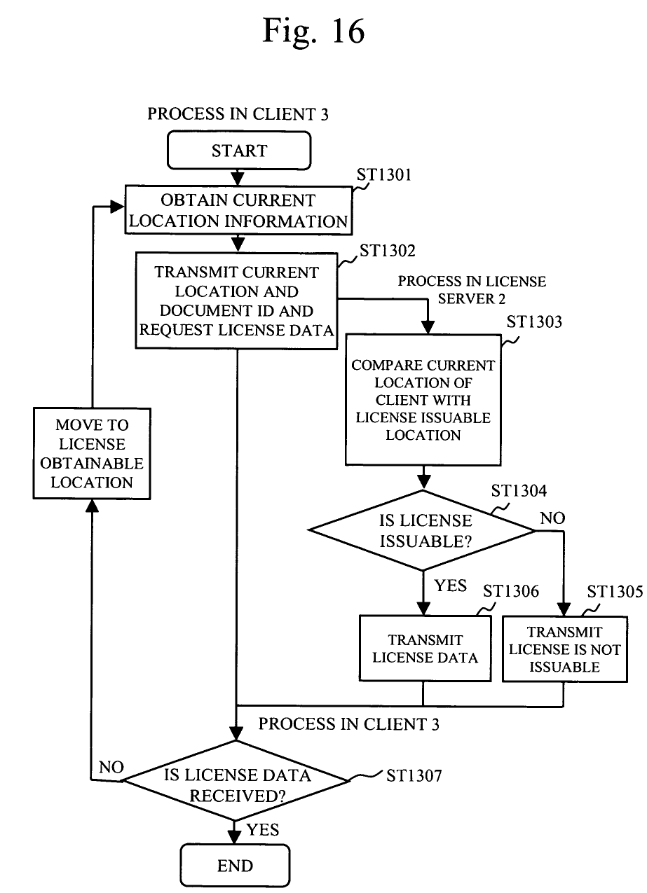

FIG. 16 is a flowchart of a process for deciding whether the license is issuable based on the current location. In Step ST1301, the current location identifying means 303 obtains current location information. If the client device 3 is not equipped with the current location identifying means 303, the current location information cannot be obtained, and therefore, it is possible to inform the user at this point that browsing of digital contents is not allowed since the current location cannot be obtained. In this way, it is possible to enhance the security level of the system by allowing browsing of the digital contents to only the client device 3 in compliance with particular specifications.

Next, in Step ST1302, the content utilizing application opens prescribed encrypted document data, and the license data processing unit 302 transmits a document ID of the opened document data and the current location obtained by the current location identifying means 303, and requests the license data 4 to the license server device 2.

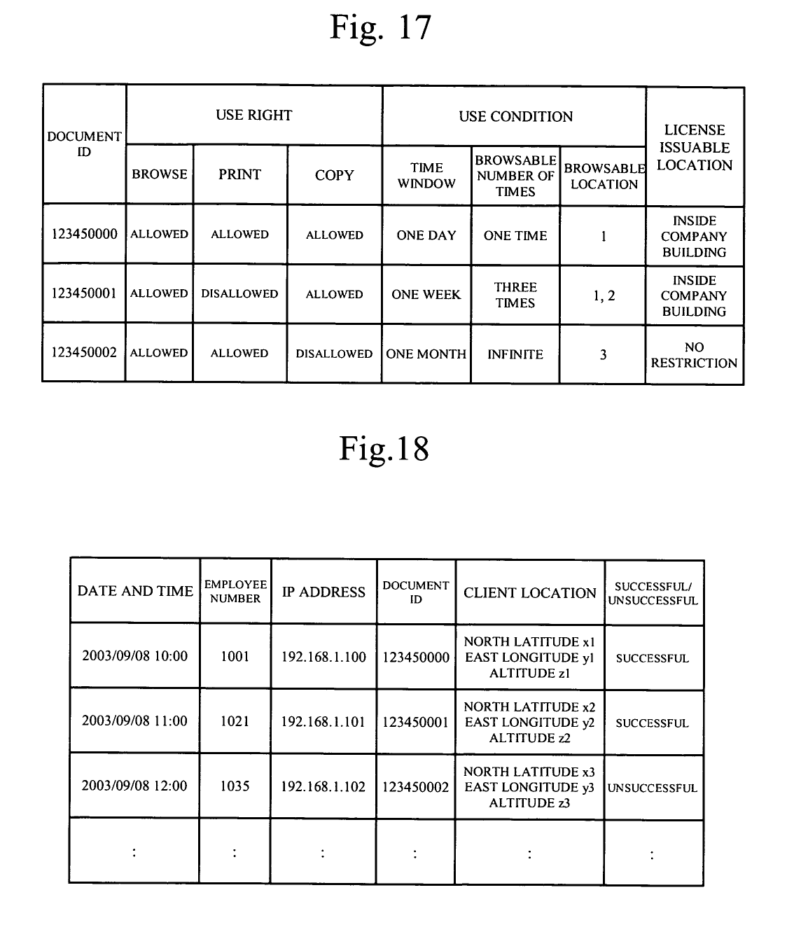

In Step ST1303, the license server device 2 obtains a license issuable location of the document ID 105. This is realized, for example, by preparing a use right-use condition table beforehand for attributions associated with each document ID as shown in FIG. 17. When the document ID is 123450000, the license issuable location is limited inside the company building. Next, in Step ST1304, the current location of the client device 3 and the license issuable location are compared, and if the license data 4 is issuable, the license data 4 is generated in Step 1306, and is returned to the client device 3. If it is not allowed to issue the license data 4, in Step ST1305, disallowance of license issuance is reported to the client device.

Next, in Step ST1307, the client device 3 judges whether or not the license data is received, and when the license data cannot be received, the client device 3 is moved to a license obtainable location again in Step ST1308, and the processes from Step ST1301 are repeated. When the license data can be obtained, the license data requesting process is completed.

In the afore-mentioned operations, it is possible to enhance the security level by limiting not only the document available location, but also a location to issue the license data for using documents.

(Analytic Support Functions of Fraudulent License Data Issuance Request)

In the above-mentioned processes, it is possible to record the license issuance request so that when a fraudulent request for license issuance is made, information useful for identifying criminals can be obtained. The license issuance history recording unit 216 in FIG. 3 is a part to keep such records. In the license server device 2, the license issuance history recording unit 216 fully records issuance of license data according to license data issuance requests from the client device 3 to the license issuance history database 217. An example of the license issuance history database 217 is shown in FIG. 18. Location information of the client device that requested license data is recorded as well as date and time of license issuance, a user ID, an IP address and a document ID. Further, results of whether the license data is properly obtained are also recorded.

The administrator can refer to the license issuance history database 217 periodically, and detect a fraudulent access operation from events such as repeat of failures in authentication. Further, since the location information of the client device 3 that requested the license data is recorded, a geographical location of the criminal can be judged, and therefore, has an effect on identification of criminals.

As it is apparent from the above description, according to this digital content use right management system, it is possible to allow reference to digital contents only at a predetermined place since availability of the digital contents can be controlled depending on a browsing location of users.

In contrary to the configuration that allows browsing of digital contents only when the client device 3 is at a predetermined location, it is also possible to adopt the configuration that does not allow browsing of digital contents when the client device 3 is at a certain location. Specifically, in the license data of FIG. 5, an <available_location> tag in the use condition 402 can be rewritten as <available_location range=“out”>. In this way, it is possible to designate a conference room that people from outside the company can enter, and to make the document unavailable in the room, and therefore, an effect to enhance the security level can be obtained.

The client device 3 according to the present invention in the above description is equipped with a single current location identifying means 303 such as a GPS antenna. However, when the client device 3 is equipped with a plurality of methods to identify a current location, such as a GPS antenna, a PHS and an electronic tag, it is also possible to make the document available when it is confirmed that the client device 3 is in the document available location by combining location information identified by the plurality of the current location identifying means.

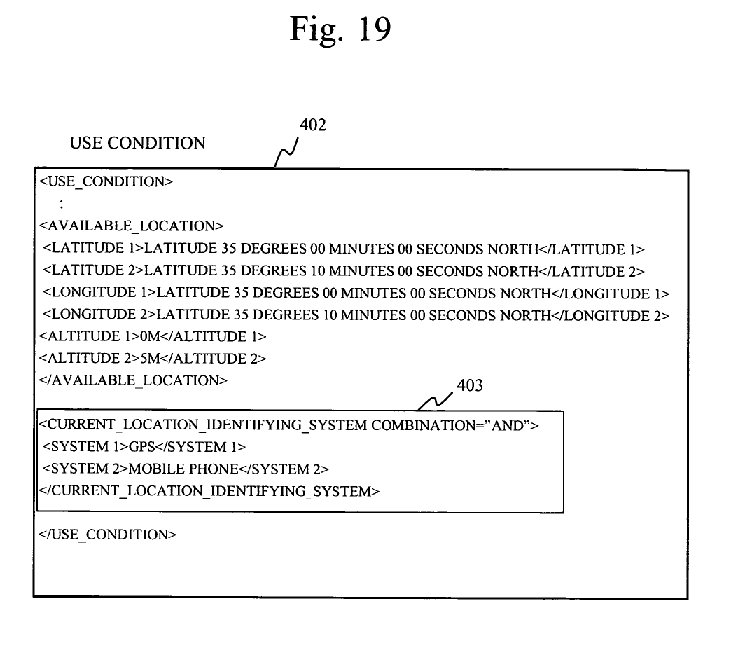

FIG. 19 is an example of a structure of license data that allows utilization of documents when a location can be identified by both a GPS and a mobile phone. A reference number 403 in this diagram is a part describing the use condition. In this way, by providing a tag <current_location_identifying_system> describing a current location identifying system, and setting the attribution notation of the tag as “combination=“AND”.”, it is possible to allow reference to digital contents only when the location identification is performed by both the GPS and the mobile phone indicated in the following systems 1 and 2.

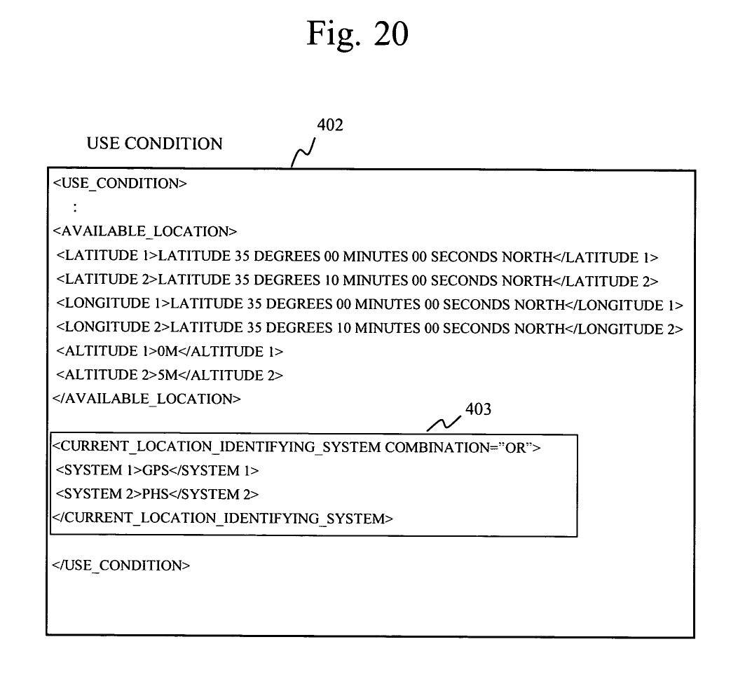

Further, FIG. 20 shows an example in which the attribution notation of the tag of the current location identifying system is “combination=“OR””. This indicates that it is enough if either the GPS or the PHS indicated in the following systems 1 and 2 can identify the location.

By interpreting the above-mentioned use condition notation system of the license data 4, the license data processing unit 302 of the client device 3 judges whether the digital content is browsable or not.

By this configuration, when a malicious user attempts falsification of the location information, the user has to falsify a plurality of the location information, therefore, it is possible to obtain an effect to enhance tamper-proofness. Further, when a GPS is mounted on a notebook PC and a mobile phone can be attached to the notebook PC in this configuration, as long as the mobile phone is possessed, there is no possibility for documents to be used even when the notebook PC is stolen. Therefore, it is possible to obtain an effect to enhance the security level.

Further, it is possible to obtain an effect for enlarging the document available area by utilizing redundancy of the current location identification means and a plurality of the location identifying means.

In the above-mentioned explanation, browsing and displaying are mainly described as use forms of digital contents. However, it is also possible to use the technologies in this digital content management system for judging the other use forms, such as whether or not to allow printing process. Moreover, while the above-mentioned explanation is made based on document data, it goes without saying that this system can be used for judging the availability of digital contents such as music, voices, still images, pictures like movies and computer programs.

### Embodiment 2

Next, it is described a digital content use right management system wherein an elevator maintenance company can limit browsing of elevator maintenance manuals to certain maintainers and certain places. The contents of the maintenance manuals are important confidential matters for elevator maintenance companies, and it is one of their important matters to prevent leakage to third parties, especially to competitors. Further, the maintenance manuals differ from elevator to elevator installed in various regions, and a maintenance work according to a wrong maintenance manual may become a cause to threaten the safety of elevators. It is one of the purposes of the digital content use right management system to resolve such problems.

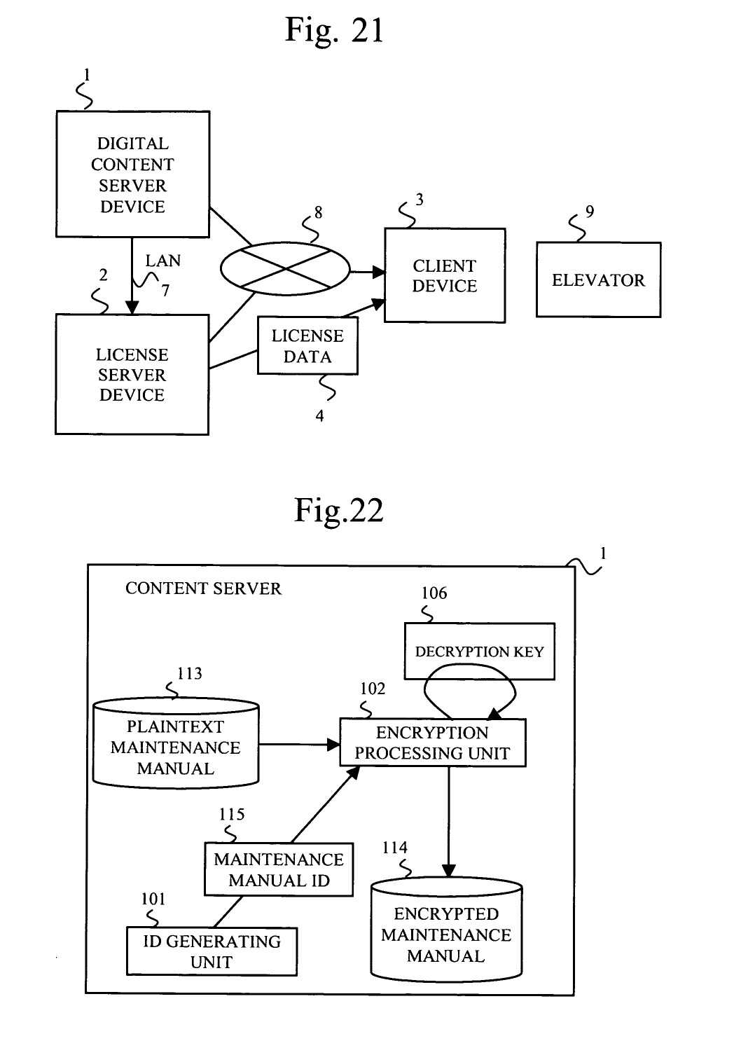

FIG. 21 is a block diagram showing a structure of such digital content use right management system. In the diagram, an elevator 9 is an elevator as a subject of maintenance. The elevator 9 is internally equipped with a micro computer and a memory, or a circuit or an element corresponding to those, wherein an elevator ID as an ID unique to the elevator is stored, and additionally equipped with an ID transmitter, whereby the stored elevator ID is broadcasted externally. The other components to which the same reference numbers are attached as in FIG. 1 are similar to those in the first embodiment, and therefore, explanations thereof are omitted.

Next, a detailed structure of each component in the digital content use right management system according to the second embodiment of the present invention is described. FIG. 22 is a block diagram showing a detailed structure of a digital content server device 1 in the second embodiment of the present invention. In the diagram, a plaintext maintenance manual 113 is a document file corresponding to the plaintext document data 103 in FIG. 2, and the maintenance manual document data whereon an encryption process is not performed. An encrypted maintenance manual 114 is an electronic file generated by encrypting the plaintext maintenance manual 113, which corresponds to the encrypted document data 104 in FIG. 2. A maintenance manual ID 115 is a document ID provided to the encrypted maintenance manual 114, which corresponds to the document 105 in FIG. 2. The other components to which the same reference numbers are attached as in FIG. 2 are similar to those in the first embodiment, and therefore, explanations thereof are omitted.

Next, in FIG. 23 is a block diagram showing a detailed structure of a license server device 2 according to the second embodiment of the present invention. In the diagram, an elevator database 212 is a file that stores relations between elevator IDs uniquely assigned to each elevator at the time of installation, and the corresponding maintenance manual IDs. The other components to which the same reference numbers are attached as in FIG. 3 are similar to those in the first embodiment, and therefore, explanations thereof are omitted.

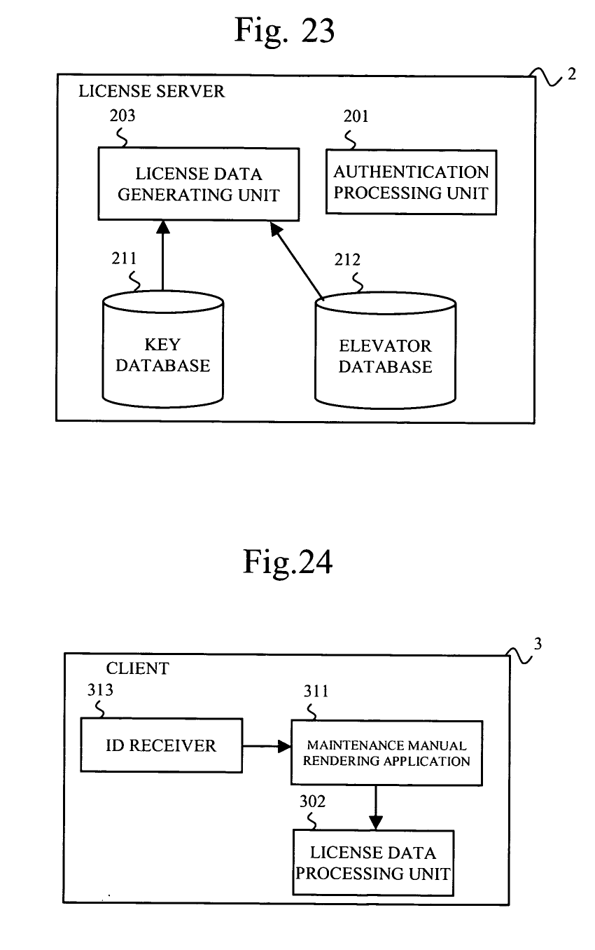

Next, FIG. 24 is a block diagram showing a detailed structure of a client device 3 according to the second embodiment of the present invention. A maintenance manual rendering application 311 is a computer program for displaying the maintenance manual on a display. An ID receiver 313 is a receiver that receives the elevator ID transmitted by the ID transmitter of the elevator 9 as radio information. The other component to which the same reference number is attached as in FIG. 4 is similar to that in the first embodiment, and therefore, explanation thereof is omitted.

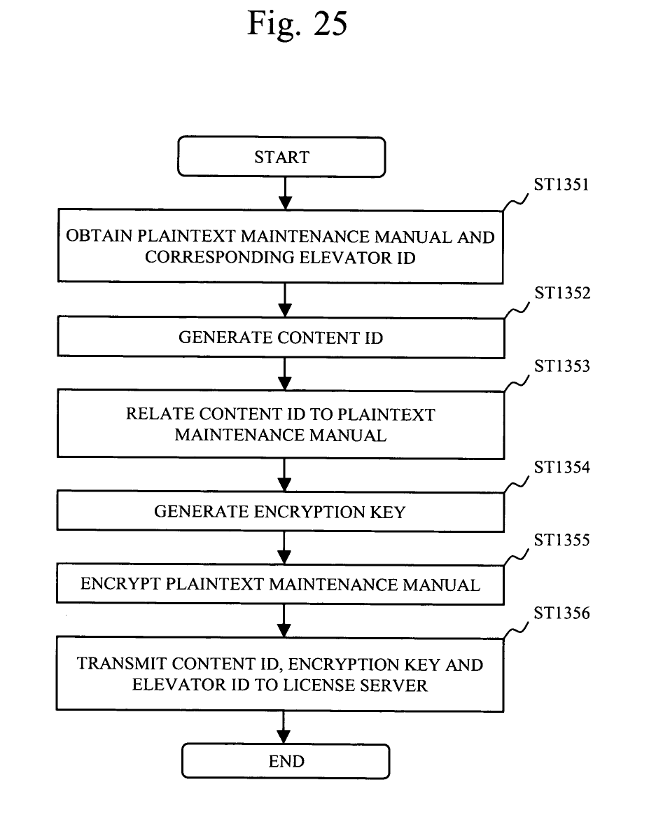

Next, operations in the digital content use right management system are described. FIG. 25 is a flowchart of processes in the digital content server device 1. First, in Step ST1351 in the diagram, the encryption processing unit 102 opens the plaintext maintenance manual 113 to be browsed by a maintainer beside an elevator, and additionally, obtains an elevator ID corresponding to the plaintext maintenance manual 113 from an input device not shown in the diagram, such as a keyboard. Next, in Step ST1352, the ID generating unit 101 generates the maintenance manual ID 115. In Step ST1353, the encryption processing unit 102 relates the maintenance manual ID 105 to the plaintext maintenance manual 113. In Step ST1354, the encryption processing unit 102 generates an encryption key (equal to a decryption key 106). In Step ST1355, the encryption processing unit 102 encrypts the plaintext maintenance manual 113, and obtains the encrypted maintenance manual 114. Finally, in Step ST1356, the maintenance manual ID 105, the encryption key (equal to the decryption key 106) and the elevator ID are transmitted to the license server device 2.

Next, the license server device 2 registers a pair of the maintenance manual ID 105 and the encryption key (equal to the decryption key 106) transmitted from the digital content server device 1 in a key database 211, and keeps them. The contents of the key database 211 registered as a result are similar to those described in FIG. 9.

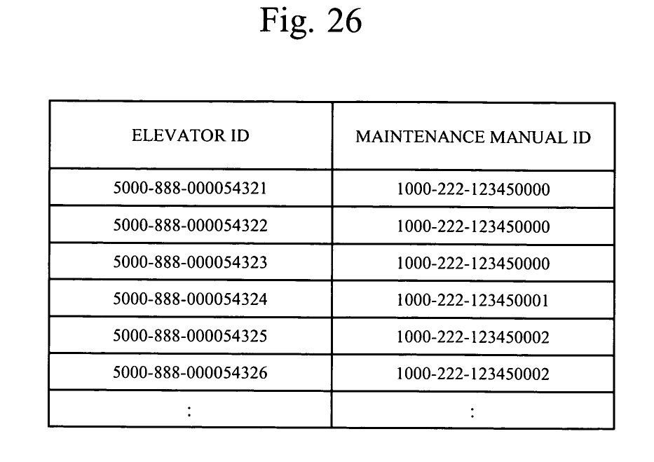

Further, the license server device 2 registers the elevator ID and the maintenance manual ID 105 in the elevator database 212. An example of a table structure of the elevator database 212 is described in FIG. 26. As shown in the example of the diagram, the elevator database is a table relating the elevator IDs and the maintenance manual IDs. The content server device 1 and the license server device 2 perform on each manual maintenance encryption process and registration process in the elevator database 212. It may be possible to assign the same maintenance manual to a plurality of elevator IDs. In the afore-mentioned processes, primary preparation of the system is completed.

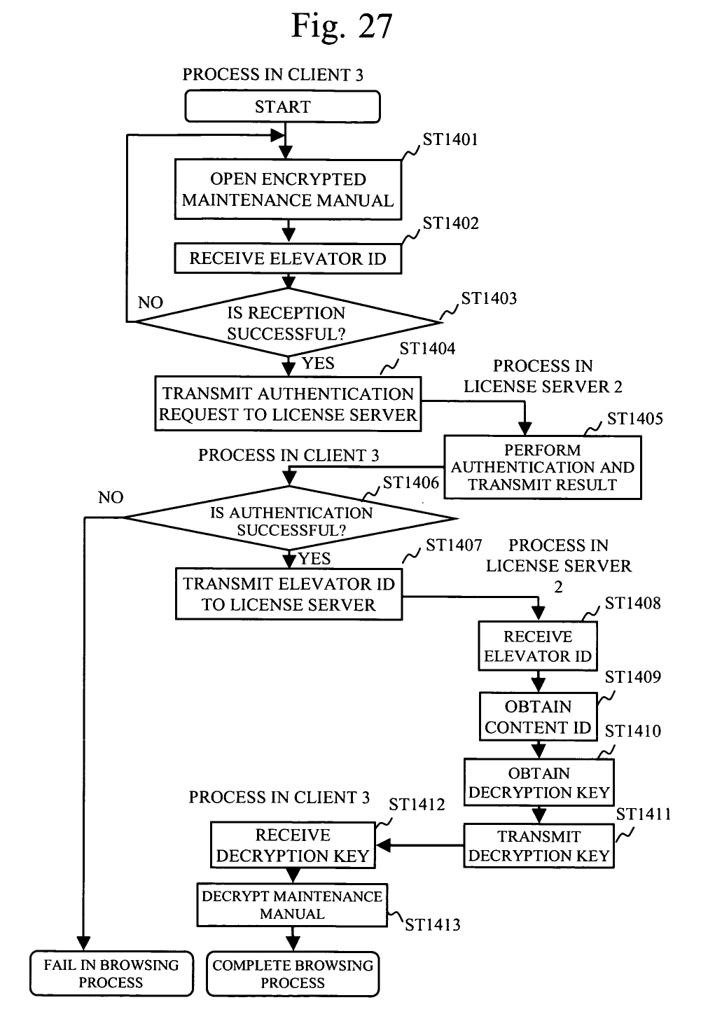

Next, it is described operations in the system when a maintainer performs elevator maintenance works by using a maintenance manual. The maintainer of an elevator connects the client device 3 to the digital content server device 1, or connects the client device 3 from the license server device 2 to the digital content server device 1 via a network such as a LAN 7 in advance of going to an installation site of the elevator as a subject of maintenance. Next, an encrypted maintenance manual corresponding to the elevator as a subject of maintenance is copied from the digital content server device 1. Then, the maintainer takes the client device 3 to the field where the elevator as a subject of maintenance is installed, and attempts to browse the maintenance manual to perform the maintenance work of the elevator. The operations in the system in such an occasion are hereinafter described. FIG. 27 is a flowchart of operations in the system at the time of browsing the maintenance manual.

First, in Step ST1401 of the diagram, a maintenance manual rendering application 311 opens the encrypted maintenance manual 113. Then, in Step ST1402, the ID receiver 313 of the client device 3 receives an elevator ID transmitted by the ID transmitter of the elevator 9. In Step ST1403, the maintenance manual rendering application 311 judges whether or not a receipt of the elevator ID is successful, and when the elevator ID cannot be received, closes the file of the encrypted maintenance manual, and the process is returned to Step ST1401. Meanwhile, the maintainer moves as needed to locations where the elevator ID can be received, and retries the processes from Step ST1401.

Further, when the elevator ID can be received (Step ST1403: Yes), the process is proceeded to Step ST1404.

In Step ST1404, the maintenance manual rendering application 311 requests a license data processing to a license data processing unit 302, and according to the request, the license data processing unit 302 transmits an authentication request to the license server device 2. At this point, an account, a password, or other arbitrary authentication information is transmitted as authentication data. Besides, the Internet 8 such as a mobile phone packet network is used for the communication. Next, in Step ST1405, an authentication processing unit 201 of the license server device 2 performs an authentication process according to the request from the client device 3, and returns the result likewise to the client device 3 via the Internet 8.

In Step ST1406, the license data processing unit 302 checks the contents of the result of the authentication, and when failure in the authentication is proven, the process is terminated, resulting in failure of browsing of the maintenance manual. On the other hand, when the authentication is successful, the process is proceeded to Step ST 1407. In Step ST1407, the license data processing unit 302 transmits the elevator ID to the license server device 2.

In Step ST1408, a license data generating unit 203 of the license server device 2 receives the elevator ID. Then, in Step ST1409, the license data generating unit 203 obtains a maintenance manual ID 115 corresponding to the elevator ID from the elevator database 12. Next, in Step ST1410, the license data generating unit 203 obtains the decryption key 106 corresponding to the maintenance manual ID 115 from the key database 211. Then in Step 1411, the license data generating unit 203 transmits the decryption key to the client device 3.

In Step ST 1412, the license data processing unit 302 of the client device 3 receives the decryption key 106, decrypts the encrypted maintenance manual 114 in Step ST1413, and renders the maintenance manual with the maintenance manual rendering application 311. In the above-mentioned manner, only in front of the elevator as a subject of maintenance, the maintainer can browse the corresponding maintenance manual.

It is possible to make the license data 4 obtained at the client device 3 available next time the maintenance manual is opened, within the scope of the use condition of the maintenance manual, such as available period and available number of times. By this configuration, it is no more necessary to obtain the license data from the license server device each time the maintenance manual is opened, and therefore, convenience for the maintainer is improved.

In this case, the license data processing unit 302 of the client device 3 allows the maintenance manual rendering application 311 to render the maintenance manual only when the elevator ID designated by the license data 4 can be obtained from the ID receiver 313.

On the other hand, when the client device 3 with the license data 4 stored therein falls into the hands of a third party due to a theft or the like, the license data 4 may be fraudulently used at the site, although the available location is limited to the place in front of the elevator. Therefore, by managing the elevator ID of the elevator 9 and the elevator ID registered on the elevator database 212 to be changed to new IDs simultaneously, the elevator ID registered in the license data 4 stored in the client device 3 stolen becomes void, and as a result, fraudulent use of the maintenance manual is prevented.

As this digital content use right management system operates in the manner mentioned above, in case of information leakage to a third party, the system behaves as hereinafter described, and has an effect on prevention of information leakage.

First, even when the client device is stolen while the maintainer moves between the company and the elevator as a subject of maintenance, the maintenance manual cannot be browsed since it is encrypted. Further, since the thief of the client device cannot obtain the elevator ID when the thief intends to obtain the license data to decrypt the maintenance manual unless the thief is near the ID transmitter of the elevator, it is impossible to connect the client device to the license server device. Moreover, even when the thief moves near to the elevator and tries to obtain the license data, the license data cannot be obtained unless the thief knows the account and the password necessary for authentication.

Thus, the digital content use right management system has an extremely advantageous effect.

Furthermore, since the maintenance manual cannot be referenced without using the decryption key corresponding to the elevator in the digital content use right management system, it is prevented occurrence of maintenance check work being performed according to a mistaken maintenance manual, and therefore, the system contributes to safe management of the elevator.

Since the present invention is configured as shown above, the effect as follows can be additionally obtained.

In the above explanation, as an application example of the digital content use right management system, the application to the maintenance work for elevators is described, however, it goes without saying that besides the maintenance work for elevators, the system can be widely applied to various maintenance check works for automatic doors, escalators, fire-alarm equipment and air-conditioning equipment, etc., or vehicle inspections.

### Embodiment 3

In the digital content management system according to the first embodiment, it is allowed to browse the conference materials depending on the location information of the conference room, etc. However, it is possible to utilize the digital content management system according to the present invention to enhance the ability to pull in customers to a theme park or an event site by replacing the conference room with a site of a theme park, and conference materials with digital contents to be browsed in the theme park. That is, the license data is set to allow browsing of the digital contents only when the location information coincides with locations of the theme park or the event site.

In such utilization method of the system, the structures and the processes of a digital content server device 1, a license server device 2 and a client device 3 are mostly the same. However, in this case, it is assumed that the client device 3 is carried by a visitor visiting the theme park, and the digital contents (encrypted document data 104) and license data 4 are downloaded beforehand by the visitor from each house or at places having facilities of Internet cafes and the like near the site by connecting to a LAN.

Further, in this utilization method of the system, it is possible to disperse attendance of visitors by adding time information and by assigning different content browsable times to each of a certain number of visitors as subjects of allowance. For the purpose, the license server device 2 counts the number of times the same types of license data 4 is distributed, and controls not to have license data 4 distributed beyond a prescribed number of times. Further, such browsable times of the contents can be kept in the license data 4. Additionally, it is possible to avoid a crowded condition in specific facilities by dividing the site of facilities or the event site into several sections and by assigning different location IDs for each section, and to allow the digital content management system to select browsable contents depending on the location IDs and the times.

As shown above, by relating the contents with locations of attractions in the theme park and locations of exhibits in the event facilities, and further with the access times, it is possible to expect effects such as to enhance the ability to pull in customers to the facilities or to resolve a crowded situation in the facilities.

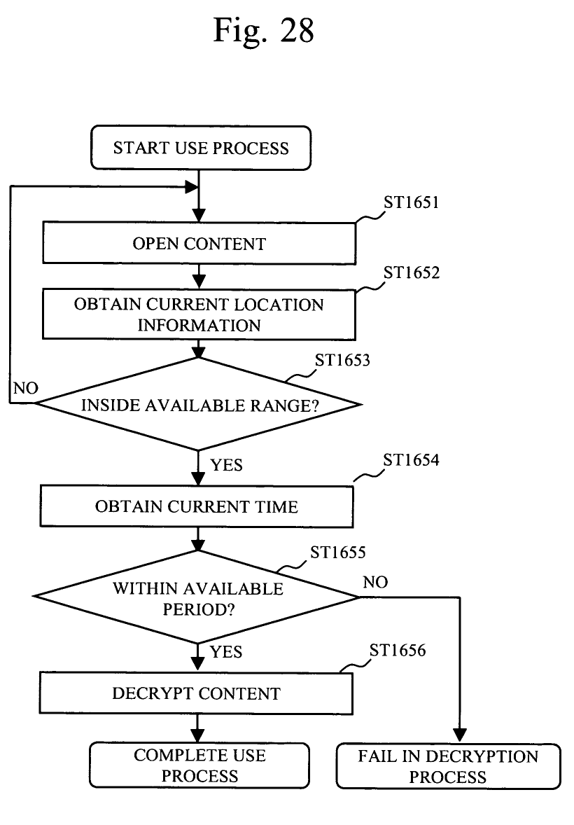

Next, it is explained processes of the digital content management system to judge whether or not digital contents are browsable when a visitor to a theme park or an event site attempts to browse the digital contents at the site. FIG. 28 is a flowchart of a digital content browsability judging process.

In Step ST1651 in the diagram, a content utilizing application 301 of the client device 3 carried by a visitor opens a digital content (encrypted document data 104) according to an operation direction by the visitor. Then, in Step ST1652, a license data processing unit 302 of the client device 3 obtains current location information by using a current location identifying means 303. Then, in Step ST1653, the license data processing unit 302 judges whether or not the current location information is within a location defined by the license data 4, from which the digital content is browsable, and when it is not within such location, closes the encrypted document data 104 opened, and the process is returned to Step ST1651.

On the other hand, when the current location information is within a location from which the digital content is browsable, the process is proceeded to Step ST1654. In Step ST1654, the license data processing unit 302 obtains a current time from a system clock mounted on the client device 3, which is not shown in the diagram. Then in Step ST1655, the license data processing unit 302 compares a digital content browsable time held by the license data 4 with the current time, and when the current time is included in the digital content browsable time, the process is proceeded to Step ST1656. On the other hand, when the current time is outside the digital content browsable time, the process is terminated resulting in failure of the decryption process. In Step ST1656, the license data processing unit 302 decrypts the encrypted document data 104 with the decryption key 106 held by the license data 4, and displays the contents of the document data for the visitor.

As it is apparent from the above explanation, the digital content management system is designed to determine whether or not digital contents are browsable depending on locations and times at which a user attempts to browse the digital contents, therefore, it has such effects as to enhance the ability to pull in customers to a theme park or an event site, and to prevent concentration to specific facilities.

### INDUSTRIAL APPLICABILITY

As described above, the digital content use right management system according to the present invention is useful for the purposes to determine availability of a digital content depending on the location.

1. A digital content management system comprising:
a digital content server device to store a digital content encrypted;
a license server device to generate and transmit license data containing a use condition of the digital content and a decryption key to decrypt the digital content; and
a client device that is connected to the digital content server device and the license server device via a network, to receive the digital content from the digital content server device, to receive the license data from the license server device, and based on a condition for use defined by the use condition in the license data, to decide whether or not to decrypt the digital content with the decryption key contained in the license data,
a digital content use right management system, wherein
the license server device generates the license data containing an available location of the digital content as the use condition, and
the client device includes a current location identifying means to obtain a current location, and a license data processing means to compare the current location obtained by the current location identifying means with the available location contained in the use condition in the license data, and to decide whether or not to perform a decryption of the digital content.

2. The digital content management system of claim 1 further comprising a piece of equipment in need of a maintenance work by a maintainer, the piece of equipment storing an ID value to uniquely identify the piece of equipment, and having a broadcasting means to broadcast the ID value to a periphery of the piece of equipment,
wherein the digital content server device stores a maintenance manual of the piece of equipment in an encrypted state as the digital content,
the license server device generates the license data containing the ID value of the piece of equipment as the use condition,
the location identifying means obtains the ID value broadcasted by the broadcasting means of the piece of equipment, and
the license data processing means decides whether or not to perform the decryption of the digital content, by comparing the current location obtained by the location identifying means with the available location in the license data, and by comparing the ID value broadcasted by the broadcasting means with the ID value in the license data.

3. The digital content management system of claim 1, wherein
the license server device generates the license data additionally containing an available time of the digital content as the use condition, and
the license processing means decides whether or not to perform the decryption of the digital content, by comparing the current location obtained by the location identifying means with the available location in the license data, and by comparing a current time with the available time in the license data.

4. The digital content management system of claim 3, wherein the license server device transmits the license data only for a prescribed number of times or less.
